(19) United States
(12) Patent Application Publication
(10) Pub. No.: US 2024/0351574 A1
(43) Pub. Date: Oct. 24, 2024

(54) METHOD AND DEVICE FOR COOLING LOCKED ROTOR DRIVING MOTOR OF VEHICLE AND VEHICLE

(71) Applicant: BYD COMPANY LIMITED, SHENZHEN (CN)

(72) Inventors: Rujie LIU, Shenzhen (CN); Chunsheng WANG, Shenzhen (CN); Boliang XU, Shenzhen (CN); Xinli CHEN, Shenzhen (CN)

(21) Appl. No.: 18/759,757

(22) Filed: Jun. 28, 2024

Related U.S. Application Data
(63) Continuation of application No. PCT/CN2023/078005, filed on Feb. 23, 2023.

(30) Foreign Application Priority Data
Feb. 28, 2022 (CN) 202210188260.0

(51) Int. Cl. B60W 20/40; B60W 10/06; B60W 10/30; B60W 50/00

(52) U.S. Cl. CPC B60W 20/40; B60W 10/06; B60W 10/30; B60W 2050/0083; B60W 2400/00; B60W 2510/087; B60W 2510/30; B60W 2710/0644; B60W 2710/0677; B60W 2710/30

(57) ABSTRACT

A method for cooling a driving motor with a locked rotor of a vehicle is disclosed. The vehicle includes the driving motor, an engine, an engine end oil pump, and a cooling flow path. The engine is configured to drive the engine end oil pump, and the cooling flow path connects the engine end oil pump to the driving motor. The method includes: in response to determining that a driving mode of the vehicle is an electric mode and that the vehicle meets a locked rotor motor trigger condition, and detecting that a current temperature of the driving motor is greater than an auxiliary cooling starting temperature of the engine, controlling the engine to start to cause the engine end oil pump to drive a coolant in the cooling flow path to cool the driving motor.

### CROSS-REFERENCE TO RELATED APPLICATIONS

This application is a continuation application of International Patent Application No. PCT/CN2023/078005, filed on Feb. 23, 2023, which is based on and claims the priority to and benefit of Chinese Patent Application No. 202210188260.0, filed on Feb. 28, 2022. The entire content of all of the above-referenced applications is incorporated herein by reference.

### FIELD

The present disclosure relates to the field of vehicle heat dissipation, and particularly, to a method and device for cooling a driving motor with a locked rotor of a vehicle and a vehicle.

### BACKGROUND

For a hybrid vehicle equipped with an electric oil pump, a cooling system is driven by the electric oil pump, and can cool a driving motor under full working conditions. However, for a hybrid vehicle without an electric oil pump, when the vehicle is in an electric mode, the cooling of the driving motor mainly depends on rotation of a wheel to drive a wheel end oil pump to perform a cooling operation. However, when the hybrid vehicle is in an electric mode, a locked rotor of the driving motor may lead to a low vehicle speed, and then the wheel end oil pump has a low rotational speed to make it impossible to provide a sufficient coolant to cool the driving motor. As a result, the service life of the driving motor is reduced or the driving motor is even burnt out.

### SUMMARY

The present disclosure provides a method and device for cooling a locked rotor driving motor with a locked rotor of a vehicle and a vehicle, to solve the technical problem that when a locked rotor occurs to a driving motor in an electric mode of the vehicle, it is impossible to provide a sufficient coolant to cool the driving motor.

A first aspect of the present disclosure provides a method for cooling a driving motor with a locked rotor of a vehicle, the vehicle includes the driving motor, an engine, an engine end oil pump, and a cooling flow path. The engine is configured to drive the engine end oil pump, and the cooling flow path connects the engine end oil pump to the driving motor. The method includes: in response to determining that a driving mode of the vehicle is an electric mode and that the vehicle meets a locked rotor motor trigger condition, and detecting that a current temperature of the driving motor is greater than an auxiliary cooling starting temperature of the engine, controlling the engine to start to cause the engine end oil pump to drive a coolant in the cooling flow path to cool the driving motor.

In an embodiment, the method further includes the following: First duration for a temperature of the driving motor to reach a first temperature is determined according to a temperature change rate of the driving motor and the current temperature of the driving motor; and in response to that the first duration is less than or equal to first preset duration, the auxiliary cooling starting temperature of the engine is reduced.

In an embodiment, in response to that the first duration is less than or equal to first preset duration, the auxiliary cooling starting temperature of the engine is reduced includes the following: a target correction offset is determined based on the temperature change rate of the driving motor and a relationship between the temperature change rate and a correction offset; and a difference between the first preset temperature and the target correction offset is determined as the auxiliary cooling starting temperature of the engine.

In an embodiment, in response to that the first duration is less than or equal to first preset duration, the auxiliary cooling starting temperature of the engine is reduced includes the following: the auxiliary cooling starting temperature of the engine is set to be equal to a second temperature less than the first preset temperature.

In an embodiment, the method further includes the following: in response to that the first duration is greater than the first preset duration, the auxiliary cooling starting temperature of the engine is equal to the first temperature.

In an embodiment, the method further includes the following: in response to first determining that the vehicle meets a locked rotor motor exit condition and that it is determined that the current temperature of the driving motor is less than an auxiliary cooling shutdown temperature of the engine, the engine is controlled to stop running after running for a second preset duration from the first determining.

In an embodiment, the first temperature is a maximum allowable temperature of the driving motor, the second temperature is a safe starting temperature of the driving motor under a locked rotor condition, and the auxiliary cooling starting temperature of the engine is less than or equal to the first temperature.

In an embodiment, the method further includes the following: A rotational speed of the engine is controlled based on the current temperature of the driving motor, where the rotational speed of the engine is correlated with the current temperature of the driving motor; and in response to that the vehicle meets the locked rotor motor trigger condition and that a flow rate of the coolant flowing through the cooling flow path of the driving motor is greater than a first cooling flow rate, a rotation speed of a cooling fan of the vehicle is increased to cool the driving motor.

In an embodiment, the method further includes the following: in response to that the vehicle meets a locked rotor motor exit condition and that a flow rate of the coolant flowing through the cooling flow path of the driving motor is less than a second cooling flow rate, the cooling fan is controlled to stop running, where the first cooling flow rate is greater than the second cooling flow rate.

In an embodiment, that the engine of the vehicle is controlled to start includes the following: The engine is controlled to output a preset rotational speed; and a cooling fan of the vehicle is controlled to run to cool the driving motor.

In an embodiment, the method further includes the following: It is determined that the vehicle meets a locked rotor motor exit condition and it is determined that the current temperature of the driving motor is less than an auxiliary cooling shutdown temperature of the engine; and the cooling fan is controlled to stop running, and the engine is controlled to stop running after a second preset duration, or the engine and the cooling fan are controlled to stop running after the second preset duration.

In an embodiment, the preset locked rotor motor trigger condition includes: a gear of the vehicle being in a forward gear or a reverse gear, a torque of the driving motor being greater than or equal to a first torque, and a vehicle speed of the vehicle being less than or equal to a first vehicle speed; and the locked rotor motor exit condition includes one or more of: the gear of the vehicle being neither in the forward gear nor in the reverse gear, the torque of the driving motor being less than a second preset torque, and the vehicle speed of the vehicle being greater than or equal to a second preset vehicle speed, where the first torque is greater than the second torque, and the first vehicle speed is less than the second vehicle speed.

In an embodiment, the vehicle includes a spill valve, and the spill valve is configured to control a flow rate of the coolant flowing through the cooling flow path of the driving motor. The method further includes the following: After the engine is started to cool the driving motor, in response to that the flow rate of the coolant flowing through the cooling flow path of the driving motor is greater than a third cooling flow rate, the spill valve of the vehicle is controlled to enter a closed state.

A second aspect of the present disclosure further provides a device for cooling a driving motor with a locked rotor of a vehicle. The vehicle includes a driving motor, an engine, an engine end oil pump, and a cooling flow path. The engine is configured to drive the engine end oil pump to run, and the cooling flow path connects the engine end oil pump to the driving motor. The device includes: a controller, configured to implement the steps of the method for cooling a driving motor with a locked rotor of a vehicle according to the first aspect described above.

A third aspect of the present disclosure further provides a non-transitory computer-readable storage medium, including a computer program stored thereon. The computer program, when executed by a processor, implements the steps of the method for cooling a driving motor with a locked rotor of a vehicle according to the first aspect described above.

A fourth aspect of the present disclosure further provides a vehicle, including a driving motor, an engine, an engine end oil pump, a cooling flow path, a temperature detector, and a controller. The engine is configured to drive the engine end oil pump to run. The cooling flow path connects the engine end oil pump to the driving motor. The temperature detector is configured to detect a current temperature of the driving motor. The controller is configured to implement the steps of the method for cooling a driving motor with a locked rotor of a vehicle according to the first aspect described above.

Through the above technical solutions, at least the following technical effects can be achieved.

If a driving mode of the vehicle is an electric mode, the vehicle meets a preset locked rotor motor trigger condition, and a current temperature of the driving motor is greater than an auxiliary cooling starting temperature of the engine, the engine of the vehicle is controlled to start, to cause the engine end oil pump of the vehicle to drive a coolant in the cooling flow path to cool the driving motor. By this method, when the vehicle is in the electric mode and a locked rotor occurs to the driving motor, the engine of the vehicle can be started to cool the driving motor, thereby solving the problem that the locked rotor of the driving motor leads to a low rotational speed of the wheel end oil pump to make it impossible to provide a sufficient coolant to cool the driving motor. As a result, the service life of the driving motor is reduced or the driving motor is even burnt out.

Other features and advantages of the present disclosure are described in detail in the subsequent implementations.

### BRIEF DESCRIPTION OF THE DRAWINGS

Accompanying drawings are to provide a further understanding of the present disclosure, and constitute a part of the specification. The accompanying drawings, together with the following implementations, are to explain the present disclosure, but do not constitute a limitation on the present disclosure. In the drawings:

FIG. 1 is a schematic diagram of a cooling system architecture;

FIG. 2 is a flowchart of a method for cooling a locked rotor driving motor of a vehicle according to an embodiment of the present disclosure;

FIG. 3 is a flowchart of another method for cooling a locked rotor driving motor of a vehicle according to an embodiment of the present disclosure;

FIG. 4 is a block diagram of a device for cooling a locked rotor driving motor of a vehicle according to an embodiment of the present disclosure;

FIG. 5 is a block diagram of a wheel according to an embodiment of the present disclosure; and

FIG. 6 is a block diagram of another wheel according to an embodiment of the present disclosure.

### REFERENCE NUMERALS

wheel end oil pump 101; engine end oil pump 102; control valve 103; driving motor 104; cooling fan 105; spill valve 106; oil tank 107; clutch 108; controller 401; vehicle 500; driving motor 501; engine 502; engine end oil pump 503; cooling flow path 504; controller 505; vehicle 600; processors 622; power supply component 626; communication component 660; memory 632.

### DETAILED DESCRIPTION

Implementations of the present disclosure are described in detail below with reference to the accompanying drawings. It should be understood that the implementations described herein are merely to illustrate and explain the present disclosure, and are not to limit the present disclosure.

It should be understood that the steps described in the method implementations of the present disclosure may be performed in different orders and/or in parallel. In addition, the method implementation may include additional steps and/or omit the steps shown. The scope of the present disclosure is not limited in this respect. The term “include” and variants thereof used herein are open-ended including, that is, “including but not limited to”. The term “based on” is “at least partially based on”. The term “an embodiment” means “at least one embodiment”. The term “another embodiment” means “at least one other embodiment”. The term “some embodiments” means “at least some embodiments”. Related definitions of other terms will be given in the following description.

It should be noted that the concepts of “first”, “second”, and the like mentioned in the present disclosure are to distinguish different devices, modules, or units, and are not to limit the order or interdependence of the functions performed by these devices, modules, or units. It should be noted that the modifications of “a” and “multiple” mentioned in the present disclosure are schematic rather than limiting, and those skilled in the art should understand that unless the context clearly indicates otherwise, they should be understood as “one or more”.

Currently, a cooling system architecture of a hybrid vehicle without an electric oil pump is shown in FIG. 1. A wheel end oil pump 101 and an engine end oil pump 102 are mechanical pumps. The wheel end oil pump 101 is driven by rotation of a wheel and is responsible for a low-pressure oil circuit (cooling and lubrication), while the engine end oil pump 102 is driven by rotation of an engine and is responsible for oil supply of a high-pressure oil circuit (hydraulic pressure of a clutch 108, and the like). In addition, a control valve 103 is arranged/disposed between the low-pressure oil circuit and the high-pressure oil circuit, and the control valve 103 includes at least a first state in which the engine end oil pump 102 is allowed to supply oil to a cooling oil circuit of a driving motor 104 and a second state in which the oil supply is off. When the hybrid vehicle is in an electric mode, the wheel end oil pump 101 is driven to perform a cooling operation mainly by the rotation of a wheel. When the hybrid vehicle is in a hybrid mode, the engine end oil pump 102 is driven by the engine to perform a cooling operation with the wheel end oil pump 101. In addition, a cooling fan 105 can also cool the driving motor 104 when operating. A spill valve 106 is an electromagnetic valve that controls a cooling flow rate of the cooling oil circle. When the driving motor 104 does not need cooling, the spill valve 106 is opened, allowing cooling oil (that is, coolant) with a minimum flow rate to flow to the driving motor 104, and the excess cooling oil flows back to an oil tank 107. The driving motor 104 is shut down when it needs to be cooled, and all the cooling oil exchanges heat with the outside through the cooling oil circuit.

However, when the hybrid vehicle is in an electric mode, a locked rotor of the driving motor may lead to a low vehicle speed, and then the wheel end oil pump has a low rotational speed to make it impossible to provide a sufficient coolant to cool the driving motor. As a result, the service life of the driving motor is reduced or the driving motor is even burnt out.

In view of this, for a hybrid vehicle without an electric oil pump, the present disclosure provides a method and device for cooling a driving motor with a locked rotor of a vehicle and a vehicle, to solve the above problems.

The technical solution of the present disclosure is described in detail below with reference to embodiments.

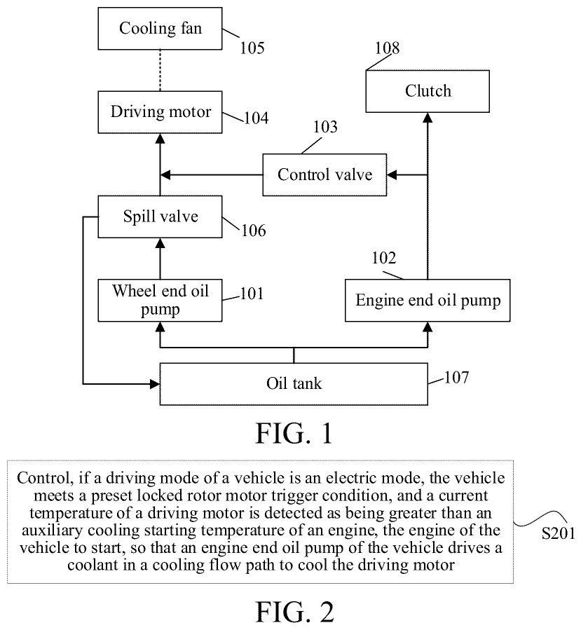

An embodiment of the present disclosure provides a method for cooling a driving motor with a locked rotor of a vehicle. The vehicle includes a driving motor, an engine, an engine end oil pump, and a cooling flow path. The engine is configured to drive the engine end oil pump to run, and the cooling flow path connects the engine end oil pump to the driving motor. As shown in FIG. 2, the method includes the following steps.

S201: If a driving mode of the vehicle is an electric mode, the vehicle meets a preset locked rotor motor trigger condition, and a current temperature of the driving motor is detected as being greater than an auxiliary cooling starting temperature of the engine, the engine of the vehicle is controlled to start, to cause the engine end oil pump of the vehicle to drive a coolant in the cooling flow path to cool the driving motor.

By means of the above method, when the vehicle is in the electric mode and a locked rotor occurs to the driving motor, the engine of the vehicle can be started to cool the driving motor, thereby solving the problem that the locked rotor of the driving motor leads to a low rotational speed of the wheel end oil pump to make it impossible to provide a sufficient coolant to cool the driving motor. As a result, the service life of the driving motor is reduced or the driving motor is even burnt out.

To make those skilled in the art better understand the method for cooling a driving motor with a locked rotor of a vehicle according to the present disclosure, the above steps are illustrated in detail below.

In an embodiment, the method further includes the following: First duration for a temperature of the driving motor to reach a first preset temperature is determined according to a temperature change rate of the driving motor and the current temperature of the driving motor; and if the first duration is less than or equal to first preset duration, the auxiliary cooling starting temperature of the engine is reduced.

For example, if the first duration is less than or equal to the first preset duration, the auxiliary cooling starting temperature of the engine being reduced may be as follows: If the first duration is less than or equal to the first preset duration, a target correction offset is determined based on the temperature change rate of the driving motor and a preset relationship between the temperature change rate and a correction offset, and then a difference between the first preset temperature and the target correction offset is determined as the auxiliary cooling starting temperature of the engine.

In an embodiment, if the first duration is less than or equal to first preset duration, the auxiliary cooling starting temperature of the engine being reduced may be as follows: If the first duration is less than or equal to first preset duration, the auxiliary cooling starting temperature of the engine is equal to a second preset temperature, where the second preset temperature is less than the first preset temperature.

The first preset temperature is a maximum allowable temperature of the driving motor, the second preset temperature is a safe starting temperature of the driving motor under a locked rotor condition, and the auxiliary cooling starting temperature of the engine is less than or equal to the first preset temperature.

It should be understood that under normal circumstances, the auxiliary cooling starting temperature of the engine is usually set to a maximum allowable temperature of the driving motor. However, due to a response delay of a temperature sensor for a certain time, when the temperature sensor detects that the current temperature of the driving motor is greater than the maximum allowable temperature, an actual temperature of the driving motor may have been already much greater than the maximum allowable temperature, leading to overheating and burning of the driving motor. Therefore, the auxiliary cooling starting temperature of the engine can be adjusted according to the current temperature change rate and the maximum allowable temperature of the driving motor. For example, the auxiliary cooling starting temperature of the engine can be reduced, so that the engine can be started in advance to participate in the cooling of the driving motor, thereby ensuring that the driving motor always operates in a reasonable temperature range and avoiding overheating and burning of the driving motor caused by the response delay of the temperature sensor.

For example, the preset relationship between the temperature change rate and the correction offset may be shown in Table 1 below. The temperature change rate is a temperature change rate of the driving motor every 3 seconds, and is obtained by rounding.

TABLE 1

| | | | | |
|---|---|---|---|---|
| Temperature change rate (° C./3 s) | 0 | 1 | 2 | 3 |
| Correction offset A (° C.) | 0 | 10 | 20 | 30 |

The auxiliary cooling starting temperature of the engine may be determined by the following calculation formula:

$$T = {T}_{0} - A ,$$

where T denotes the auxiliary cooling starting temperature of the engine, T₀ denotes the maximum allowable temperature of the driving motor, and A denotes the correction offset. The correction offset can be obtained by querying the current temperature change rate detected by the temperature sensor in Table 1.

In an embodiment, based on the safe starting temperature of the driving motor under a locked rotor condition, when the first duration is less than or equal to the first preset duration, the auxiliary cooling starting temperature of the engine is set to the safe starting temperature (second preset temperature), so that the engine can be started in advance to participate in the cooling of the driving motor, thereby ensuring that the driving motor always operates in a reasonable temperature range and avoiding overheating and burning of the driving motor caused by the response delay of the temperature sensor. In an embodiment, a relationship curve of the current temperature change rate and the auxiliary cooling starting temperature of the engine may be determined by experiments. In the relationship curve, when the current temperature change rate is 0, the auxiliary cooling starting temperature of the engine is equal to the maximum allowable temperature of the driving motor, and a larger current temperature change rate indicates a smaller auxiliary cooling starting temperature of the engine. The auxiliary cooling starting temperature of the engine is reduced based on the relationship curve, and the engine can be started in advance to cool the driving motor, to ensure that the driving motor always operates in a reasonable temperature range and avoid overheating and burning of the driving motor caused by the response delay of the temperature sensor.

In an embodiment, the method further includes the following: If the first duration is greater than the first preset duration, the auxiliary cooling starting temperature of the engine is set to be equal to the first preset temperature.

That is, when the duration for the temperature of the driving motor to reach the maximum allowable temperature is greater than the first preset duration, the driving motor is subjected to no risk of overheating and burning. Therefore, it is not necessary to start the engine in advance to participate in the cooling of the driving motor, and the auxiliary cooling starting temperature of the engine may be set to be consistent with the maximum allowable temperature. When the duration for the temperature of the driving motor to reach the maximum allowable temperature is less than or equal to the first preset duration, the driving motor is subjected to the risk of overheating and burning. Therefore, it is necessary to start the engine in advance to participate in the cooling of the driving motor, and the auxiliary cooling starting temperature of the engine is reduced to ensure that the driving motor always operates in a reasonable temperature range, and avoid overheating and burning of the driving motor caused by the response delay of the temperature sensor. The safe starting temperature may be 80° C. and the maximum allowable temperature may be 110° C., which is determined according to physical characteristics of the driving motor, and is not limited in the present disclosure. In an embodiment, the method further includes the following: If the vehicle meets a preset locked rotor motor exit condition and it is determined that the current temperature of the driving motor is less than an auxiliary cooling shutdown temperature of the engine, the engine is controlled to stop running after running for a second preset duration.

For example, when the vehicle meets the preset locked rotor motor trigger condition, the vehicle meets a preset cooling exit condition, and the current temperature of the driving motor is greater than the auxiliary cooling starting temperature of the engine, the engine is immediately started to participate in the cooling of the driving motor to avoid overheating and burning of the driving motor. Then, when the vehicle meets the preset cooling exit condition and it is determined that the current temperature of the driving motor is less than the auxiliary cooling shutdown temperature of the engine, that is, when the driving motor no longer needs the engine to participate in cooling, to avoid the loss caused by frequent starting of the engine to the engine, the engine can be shut down after a preset duration, so as to prevent a change in vehicle state in a short time, which otherwise results in restarting the engine to cool the driving motor. The auxiliary cooling shutdown temperature of the engine is determined according to the physical characteristics of the driving motor, and for example, may be 105° C., and the preset duration may be set according to experiments, and for example, may be 14 s, which is not limited in the present disclosure.

In an embodiment, the method further includes the following: A rotational speed of the engine is controlled based on the current temperature of the driving motor. The rotational speed of the engine is positively correlated with the current temperature of the driving motor. If the vehicle meets the preset locked rotor motor trigger condition and a flow rate of the coolant flowing through the cooling flow path of the driving motor is greater than a first preset cooling flow rate, a cooling fan of the vehicle is controlled to run at a maximum rotational speed to cool the driving motor.

Further, the method includes the following: If the vehicle meets a preset locked rotor motor exit condition and a flow rate of the coolant flowing through the cooling flow path of the driving motor is less than a second preset cooling flow rate, the cooling fan is controlled to stop running. The first preset cooling flow rate is greater than the second preset cooling flow rate.

It should be noted that the cooling of the driving motor may depend on that the coolant circulates in the cooling flow path, thereby taking away the heat generated by the driving motor during the operation, and exchanging heat with the outside through a heat dissipation system.

For example, the rotational speed of the engine is positively correlated with the current temperature of the driving motor, that is, when the current temperature of the driving motor is higher, faster heat dissipation is needed, so the rotational speed of the engine is higher, and a coolant flow rate driven by the engine end oil pump is larger, thereby taking away more heat. In addition, if the vehicle meets the preset locked rotor motor trigger condition and a flow rate of the coolant flowing through the cooling flow path of the driving motor is greater than a first preset cooling flow rate, a cooling fan of the vehicle is controlled to run at a maximum rotational speed to ensure that the coolant dissipates heat as soon as possible, thereby cooling the driving motor.

However, if the vehicle meets the preset locked rotor motor exit condition and the flow rate of the coolant flowing through the cooling flow path of the driving motor is less than the second preset cooling flow rate, the cooling fan is controlled to stop running. Unnecessary energy consumption caused by the cooling fan always running at the maximum rotational speed is avoided.

The first preset cooling flow rate and the second preset cooling flow rate may be determined, for example, the first preset cooling flow rate may be 3 L, and the second preset cooling flow rate may be 1.5 L, which is not limited in the present disclosure, provided that it is ensured that the first preset cooling flow rate is greater than the second preset cooling flow rate.

In an embodiment, the engine start of the vehicle may be controlled by the following method: The engine is controlled to output a preset rotational speed, and the cooling fan of the vehicle is controlled to run at a maximum rotational speed to cool the driving motor.

Further, the method further includes the following: It is determined that the vehicle meets the preset locked rotor motor exit condition, it is determined that the current temperature of the driving motor is less than the auxiliary cooling shutdown temperature of the engine, then the cooling fan is controlled to stop running, and the engine is controlled to stop running after a second preset duration. In an embodiment, the engine and the cooling fan are controlled to stop running after a second preset duration.

That is, if a driving mode of the vehicle is an electric mode, the vehicle meets the preset locked rotor motor trigger condition, and the current temperature of the driving motor is greater than the auxiliary cooling starting temperature of the engine, the engine is controlled to run at a preset rotational speed to drive the engine end oil pump, and the cooling fan of the vehicle is controlled to run at the maximum rotational speed to cool the driving motor. The preset rotational speed is determined with both heat dissipation requirements and energy saving requirements taken into account, so as to better cool the driving motor.

Further, when the vehicle meets the preset locked rotor motor exit condition and the current temperature of the driving motor is less than the auxiliary cooling shutdown temperature of the engine, the cooling fan may be controlled to stop running, and the engine is controlled to stop running after the second preset duration. In an embodiment, when the vehicle meets the preset locked rotor motor exit condition and the current temperature of the driving motor is less than the auxiliary cooling shutdown temperature of the engine, the engine and the cooling fan may be controlled to stop running after the second preset duration, to avoid unnecessary energy consumption. The second preset duration may be set as required, which is not limited in the present disclosure.

In an embodiment, the vehicle includes a spill valve, and the spill valve is configured to control a flow rate in the cooling flow path. The method further includes the following: After the engine is started to cool the driving motor, if the flow rate of the coolant flowing through the cooling flow path of the driving motor is greater than a third preset cooling flow rate, the spill valve of the vehicle is controlled to enter a forcibly closed state.

For example, after the engine is started to cool the driving motor, if the flow rate of the coolant flowing through the cooling flow path of the driving motor is greater than the third preset cooling flow rate, the spill valve of the vehicle is controlled to enter a forcibly closed state, so that all the coolant passes through the cooling flow path of the vehicle to cool the driving motor, thereby improving the cooling effect on the driving motor. Then, if the vehicle meets the above preset locked rotor motor exit condition or the flow rate of the coolant in the cooling flow path is less than the preset flow rate upon the opening of the spill valve, the spill valve is controlled to exit the forcibly closed state, so as to reduce unnecessary power consumption.

It should be noted that closing the spill valve requires power-on control, which causes a resistor therein to heat up continuously. Therefore, if the spill valve is controlled to be closed when the engine is just started, that is, when the flow rate of the coolant in the cooling flow path is low, the spill valve quickly heats up and is burned out. Therefore, in the embodiment of the present disclosure, after the engine is started to cool the driving motor, the spill valve of the vehicle is controlled to enter the forcibly closed state, to prevent the spill valve from being burnt out. Therefore, after the engine is started to cool the driving motor, the spill valve of the vehicle may be controlled based on whether the flow rate of the coolant in the cooling flow path meets preset requirements. For example, the spill valve may be controlled to be closed when the flow rate of the coolant in the cooling flow path is greater than 1.5 L, and after the spill valve is closed, the spill valve may be controlled to be opened when the flow rate of the coolant in the cooling flow path is less than 3 L, which may be set as required, and is not limited in the present disclosure.

In an embodiment, the preset locked rotor motor trigger condition includes: a gear of the vehicle is in a forward gear or a reverse gear, a torque of the driving motor is greater than or equal to a first preset torque, and a vehicle speed of the vehicle is less than or equal to a first preset vehicle speed. The preset locked rotor motor exit condition includes one or more of the following: the gear of the vehicle is neither in the forward gear nor in the reverse gear, the torque of the driving motor is less than a second preset torque, and the vehicle speed of the vehicle is greater than or equal to a second preset vehicle speed. The first preset torque is greater than the second preset torque, and the first preset vehicle speed is less than the second preset vehicle speed.

For example, the first preset torque, the first preset vehicle speed, and the first preset temperature may be determined according to experiments and physical characteristics of the vehicle. For example, the first preset torque may be 150 N·m and the first preset vehicle speed may be 3 KM/h, which is not limited in the present disclosure. The second preset torque, the second preset vehicle speed, and the second preset temperature are determined according to experiments and physical characteristics of the vehicle. For example, the second preset torque may be 10 N·m and the second preset vehicle speed may be 5 KM/h, which is not limited in the present disclosure.

For example, when the vehicle is in the electric mode, and the vehicle meets requirements for a gear of the vehicle being in the forward gear or the reverse gear, the torque of the driving motor being greater than or equal to the first preset torque, the current vehicle speed of the vehicle being less than or equal to the first preset vehicle speed, and the current temperature of the driving motor being greater than the auxiliary cooling starting temperature of the engine, it can be determined that the driving motor of the vehicle is in a locked rotor state and needs to be cooled, and then the engine is started, so that the engine end oil pump of the vehicle drives the coolant in the cooling flow path to cool the driving motor. As a result, the service life of the driving motor is reduced or the driving motor is even burnt out. Then, when the vehicle meets the preset locked rotor motor exit condition, that is, when the driving motor no longer needs the engine to participate in cooling, to avoid the loss caused by frequent starting of the engine to the engine, the engine may be shut down after preset duration.

Further, when the current vehicle speed is greater than the first preset vehicle speed and less than the second preset vehicle speed, or when the torque of the driving motor is less than the first preset torque and greater than the second preset torque, the engine may be kept in the current operating state, so as to reduce the impact of vehicle speed fluctuation or torque fluctuation on the operating state of the engine and avoid the loss caused by frequent starting of the engine to the engine.

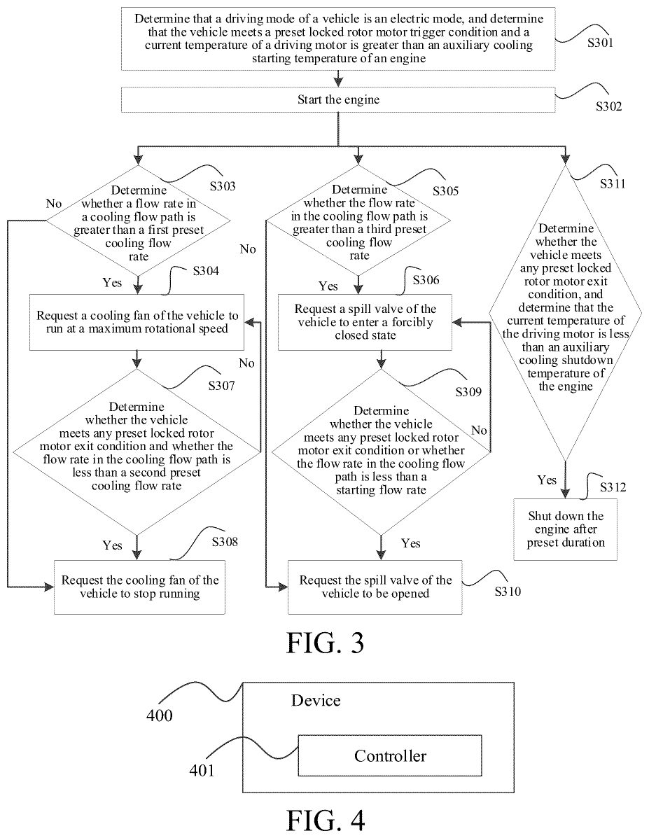

To make those skilled in the art understand the method according to the embodiment of the present disclosure more easily, the steps of the method for cooling a driving motor with a locked rotor of a vehicle are described in detail below. As shown in FIG. 3, the method includes the following steps.
S301: It is determined that a driving mode of the vehicle is an electric mode, and it is determined that the vehicle meets a preset locked rotor motor trigger condition and a current temperature of the driving motor is greater than an auxiliary cooling starting temperature of an engine.
Step S302: The engine of the vehicle is started.
S303: It is determined whether a flow rate of the coolant in a cooling flow path is greater than a first preset cooling flow rate.

Further, if the flow rate of the coolant in the cooling flow path is greater than the first preset cooling flow rate, step S304 is performed, or else step S308 is performed.
S304: A cooling fan of the vehicle is requested to run at a maximum rotational speed.
S305: It is determined whether the flow rate of the coolant in the cooling flow path is greater than a third preset cooling flow rate.

Further, if the flow rate of the coolant in the cooling flow path is greater than the third preset cooling flow rate, step S306 is performed, or else step S310 is performed.
S306: A spill valve of the vehicle is requested to enter a forcibly closed state.
S307: It is determined whether the vehicle meets any preset locked rotor motor exit condition and whether the flow rate of the coolant in the cooling flow path is less than a second preset cooling flow rate.

Further, if the vehicle meets any preset locked rotor motor exit condition and the flow rate of the coolant in the cooling flow path is less than the second preset cooling flow rate, step S308 is performed, otherwise step S304 is performed.
S308: The cooling fan of the vehicle is requested to stop running.
S309: It is determined whether the vehicle meets any preset locked rotor motor exit condition or whether the flow rate of the coolant in the cooling flow path is less than an opening flow rate.

Further, if the vehicle meets any preset locked rotor motor exit condition or the flow rate of the coolant in the cooling flow path is less than the opening flow rate, step S310 is performed, otherwise step S306 is performed.
S310: The spill valve of the vehicle is requested to be opened.
S311: It is determined whether the vehicle meets any preset locked rotor motor exit condition and it is determined that the current temperature of the driving motor is less than an auxiliary cooling shutdown temperature of the engine.

Further, if the vehicle meets any preset locked rotor motor exit condition and it is determined that the current temperature of the driving motor is less than the auxiliary cooling shutdown temperature of the engine, step S312 is performed, or else the engine is kept in a started state.
S312: The engine is shut down after preset duration.

By the method, the engine of the vehicle can be started when the vehicle is in the electric mode and a locked rotor occurs to the driving motor, so that the engine end oil pump of the vehicle drives the coolant in the cooling flow path to cool the driving motor, so as to solve the problem that the locked rotor of the driving motor leads to a low rotational speed of the wheel end oil pump to make it impossible to provide a sufficient coolant to cool the driving motor. As a result, the service life of the driving motor is reduced or the driving motor is even burnt out. Furthermore, the heat exchange with the outside is accelerated by controlling the cooling fan and the spill valve, so as to improve the cooling effect on the driving motor.

Based on the similar inventive concept, the present disclosure further provides a device for cooling a driving motor with a locked rotor of a vehicle. The vehicle includes a driving motor, an engine, an engine end oil pump, a temperature detector, and a cooling flow path. The engine is configured to drive the engine end oil pump to run, and the cooling flow path connects the engine end oil pump to the driving motor. The temperature detector configured to detect a current temperature of the driving motor. For example, the temperature detector may be a thermal couple or other temperature sensors. As shown in FIG. 4, the device 400 includes:
a controller 401, configured to implement the steps of the method for cooling a driving motor with a locked rotor of a vehicle described above.

In an embodiment, the controller 401 is configured to:
control, if a driving mode of the vehicle is an electric mode, the vehicle meets a preset locked rotor motor trigger condition, and a current temperature of the driving motor is greater than an auxiliary cooling starting temperature of the engine, the engine of the vehicle to start, to cause the engine end oil pump of the vehicle to drive a coolant in the cooling flow path to cool the driving motor.

In an embodiment, the controller 401 is further configured to:
determine first duration for a temperature of the driving motor to reach a first preset temperature according to a temperature change rate of the driving motor and the current temperature of the driving motor; and
reduce the auxiliary cooling starting temperature of the engine if the first duration is less than or equal to a first preset duration.

In an embodiment, the controller 401 is further configured to:
determine, if the first duration is less than or equal to the first preset duration, a target correction offset based on the temperature change rate of the driving motor and a preset relationship between the temperature change rate and a correction offset; and
take a difference between the first preset temperature and the target correction offset as the auxiliary cooling starting temperature of the engine.

In an embodiment, the controller 401 is further configured so that,
if the first duration is less than or equal to a first preset duration, the auxiliary cooling starting temperature of the engine is equal to a second preset temperature, where the second preset temperature is less than the first preset temperature.

In an embodiment, the controller 401 is further configured so that,
if the first duration is greater than the first preset duration, the auxiliary cooling starting temperature of the engine is equal to the first preset temperature.

In an embodiment, the controller 401 is further configured to:
control, if the vehicle meets a preset locked rotor motor exit condition and it is determined that the current temperature of the driving motor is less than an auxiliary cooling shutdown temperature of the engine, the engine to stop running after a second preset duration.

In an embodiment, the first preset temperature is a maximum allowable temperature of the driving motor, the second preset temperature is a safe starting temperature of the driving motor under a locked rotor condition, and the auxiliary cooling starting temperature of the engine is less than or equal to the first preset temperature.

In an embodiment, the controller 401 is further configured to:
control a rotational speed of the engine based on the current temperature of the driving motor, where the rotational speed of the engine is positively correlated with the current temperature of the driving motor; and
control, if the vehicle meets the preset locked rotor motor trigger condition and a flow rate of the coolant flowing through the cooling flow path of the driving motor is greater than a first preset cooling flow rate, a cooling fan of the vehicle to run at a maximum rotational speed to cool the driving motor.

In an embodiment, the controller 401 is further configured to:
control, if the vehicle meets a preset locked rotor motor exit condition and a flow rate of the coolant flowing through the cooling flow path of the driving motor is less than a second preset cooling flow rate, the cooling fan to stop running,
where the first preset cooling flow rate is greater than the second preset cooling flow rate.

In an embodiment, the controller 401 is configured to:
control the engine is to output a preset rotational speed; and
control a cooling fan of the vehicle to run at a maximum rotational speed to cool the driving motor.

In an embodiment, the controller 401 is further configured to:
determine that the vehicle meets a preset locked rotor motor exit condition and determine that the current temperature of the driving motor is less than an auxiliary cooling shutdown temperature of the engine; and
control the cooling fan to stop running, and control the engine to stop running after a second preset duration; or control the engine and the cooling fan to stop running after a second preset duration.

In an embodiment, the preset locked rotor motor trigger condition includes: a gear of the vehicle is in a forward gear or a reverse gear, a torque of the driving motor is greater than or equal to a first preset torque, and a vehicle speed of the vehicle is less than or equal to a first preset vehicle speed; and
the preset locked rotor motor exit condition includes one or more of the following: the gear of the vehicle is neither in the forward gear nor in the reverse gear, the torque of the driving motor is less than a second preset torque, and the vehicle speed of the vehicle is greater than or equal to a second preset vehicle speed,
where the first preset torque is greater than the second preset torque, and the first preset vehicle speed is less than the second preset vehicle speed.

In an embodiment, the vehicle includes a spill valve, and the spill valve is configured to control a flow rate of the coolant in the cooling flow path. The controller 401 is further configured to:
request, after the engine is started to cool the driving motor, if the flow rate of the coolant flowing through the cooling flow path of the driving motor is greater than a third preset cooling flow rate, the spill valve of the vehicle to enter a forcibly closed state.

By the above device, when the vehicle is in the electric mode and a locked rotor occurs to the driving motor, the engine of the vehicle can be started to cool the driving motor, thereby solving the problem that the locked rotor of the driving motor leads to a low rotational speed of the wheel end oil pump to make it impossible to provide a sufficient coolant to cool the driving motor. As a result, the service life of the driving motor is reduced or the driving motor is even burnt out.

With regard to the device in the above-mentioned embodiments, the way in which each module performs operations has been described in detail in the embodiments related to the method, and is not described in detail herein.

An embodiment of the present disclosure further provides a non-transitory computer-readable storage medium, having a computer program stored thereon. The computer program, when executed by a processor, implements the steps of the method for cooling a driving motor with a locked rotor of a vehicle according to the above embodiments.

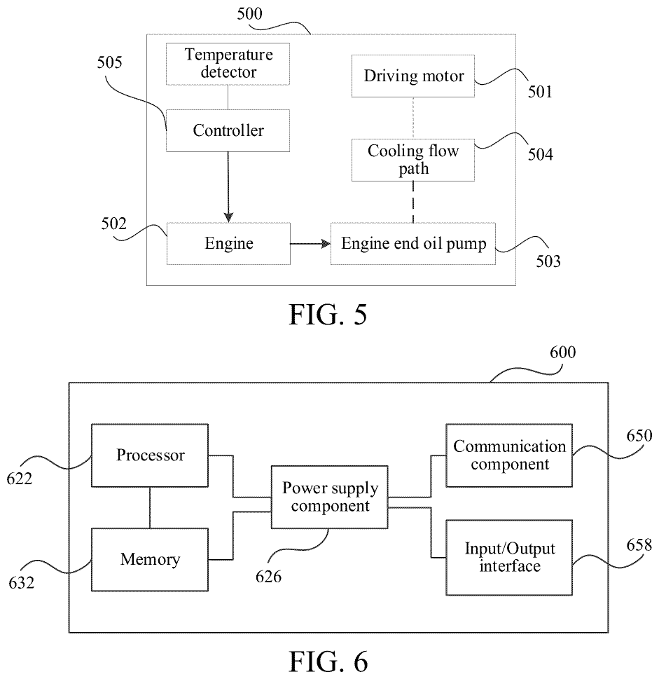

An embodiment of the present disclosure further provides a vehicle 500, as shown in FIG. 5, including a driving motor 501, an engine 502, an engine end oil pump 503, a cooling flow path 504, and a controller 505.

The engine 502 is configured to drive the engine end oil pump 503 to run.

The cooling flow path 504 connects the engine end oil pump 503 to the driving motor 501.

The controller 505 is configured to implement the steps of the method for cooling a driving motor with a locked rotor of a vehicle according to the above embodiments.

An embodiment of the present disclosure further provides a vehicle, including:
a memory, having a computer program stored thereon; and
a processor, configured to execute the computer program in the memory to implement the steps of the method for cooling a driving motor according to the above embodiments.

FIG. 6 is a block diagram illustrating another vehicle 600 according to an embodiment. Referring to FIG. 6, the vehicle 600 includes one or more processors 622, and a memory 632 configured to store a computer program executable by the processor 622. The computer program stored in the memory 632 may include one or more modules each corresponding to a set of instructions. In addition, the processor 622 may be configured to execute the computer program, to perform the method for cooling a driving motor described above.

In addition, the vehicle 600 may further include a power supply component 626 and a communication component 660. The power supply component 626 may be configured to perform power management of the vehicle 600. The communication component 660 may be configured to implement communication of the vehicle 600, such as wired or wireless communication. In addition, the vehicle 600 may further include an input/output (I/O) interface 668. The vehicle 600 may operate based on an operating system stored in the memory 632, such as Windows Server™, Mac OS X™, Unix™, and Linux™.

In another embodiment, a non-transitory computer-readable storage medium including program instructions is further provided. The program instructions, when executed by a processor, implement the steps of the method for cooling a driving motor described above. For example, the non-transitory computer-readable storage medium may be the above-mentioned memory 632 including program instructions, and the above-mentioned program instructions may be executed by the processor 622 of the vehicle 600 to complete the method for cooling a driving motor described above.

In another embodiment, a computer program product is further provided. The computer program product includes a computer program executable by a programmable device. The computer program has a code portion for performing the method for cooling a driving motor with a locked rotor of a vehicle described above when executed by the programmable device.

The implementations of the present disclosure are described above in detail with reference to the accompanying drawings, but the present disclosure is not limited to the details in the above-mentioned implementations. Within the technical concept of the present disclosure, various simple modifications can be made to the technical solutions of the present disclosure, and these simple modifications all fall within the protection scope of the present disclosure.

In addition, it should be noted that the technical features described in the above-mentioned implementations can be combined in any suitable way without contradiction. To prevent unnecessary repetition, various possible combinations are no longer explained separately in the present disclosure.

In addition, various implementations of the present disclosure can also be arbitrarily combined, provided that they do not depart from the idea of the present disclosure, which should also be regarded as the contents disclosed in the present disclosure.

What is claimed is:

1. A method for cooling a driving motor with a locked rotor of a vehicle, the vehicle comprising the driving motor, an engine, an engine end oil pump, and a cooling flow path, the engine being configured to drive the engine end oil pump, and the cooling flow path connecting the engine end oil pump to the driving motor, the method comprising:
in response to determining that a driving mode of the vehicle is an electric mode and that the vehicle meets a locked rotor motor trigger condition, and detecting that a current temperature of the driving motor is greater than an auxiliary cooling starting temperature of the engine, controlling the engine to start to cause the engine end oil pump to drive a coolant in the cooling flow path to cool the driving motor.

2. The method according to claim 1, further comprising:
determining a first duration for a temperature of the driving motor to reach a first temperature according to a temperature change rate of the driving motor and the current temperature of the driving motor; and
in response to that the first duration is less than or equal to a first preset duration, reducing the auxiliary cooling starting temperature of the engine.

3. The method according to claim 2, wherein in response to that the first duration is less than or equal to the first preset duration, the reducing the auxiliary cooling starting temperature of the engine comprises:
determining a target correction offset based on the temperature change rate of the driving motor and a relationship between the temperature change rate and a correction offset; and
determining a difference between the first temperature and the target correction offset as the auxiliary cooling starting temperature of the engine.

4. The method according to claim 2, wherein in response to that the first duration is less than or equal to the first preset duration, the reducing the auxiliary cooling starting temperature of the engine comprises:
setting the auxiliary cooling starting temperature of the engine to be equal to a second temperature less than the first temperature.

5. The method according to claim 2, further comprising:
in response to that the first duration is greater than the first preset duration, setting the auxiliary cooling starting temperature of the engine to be equal to the first temperature.

6. The method according to claim 1, further comprising:
in response to first determining that the vehicle meets a locked rotor motor exit condition and that the current temperature of the driving motor is less than an auxiliary cooling shutdown temperature of the engine, controlling the engine to stop running after running for a second preset duration from the first determining.

7. The method according to claim 4, wherein the first temperature is a maximum allowable temperature of the driving motor, the second temperature is a safe starting temperature of the driving motor under a locked rotor condition, and the auxiliary cooling starting temperature of the engine is less than or equal to the first temperature.

8. The method according to claim 1, further comprising:
controlling a rotational speed of the engine based on the current temperature of the driving motor, wherein the rotational speed of the engine is correlated with the current temperature of the driving motor; and
in response to that the vehicle meets the locked rotor motor trigger condition and that a flow rate of the coolant flowing through the cooling flow path of the driving motor is greater than a first cooling flow rate, increasing a rotation speed of a cooling fan of the vehicle to cool the driving motor.

9. The method according to claim 8, further comprising:
in response to that the vehicle meets a locked rotor motor exit condition and that the flow rate of the coolant flowing through the cooling flow path of the driving motor is less than a second cooling flow rate, controlling the cooling fan to stop running,
wherein the first cooling flow rate is greater than the second cooling flow rate.

10. The method according to claim 1, wherein the controlling the engine to start comprises:
controlling the engine to output a preset rotational speed; and
controlling a cooling fan of the vehicle to run to cool the driving motor.

11. The method according to claim 10, further comprising:
determining that the vehicle meets a locked rotor motor exit condition and determining that the current temperature of the driving motor is less than an auxiliary cooling shutdown temperature of the engine; and
controlling the cooling fan to stop running, and controlling the engine to stop running after a second preset duration; or controlling the engine and the cooling fan to stop running after a second preset duration.

12. The method according to claim 6, wherein
the locked rotor motor trigger condition comprises: a gear of the vehicle being in a forward gear or a reverse gear, a torque of the driving motor being greater than or equal to a first torque, and a vehicle speed of the vehicle being less than or equal to a first vehicle speed,
the locked rotor motor exit condition comprises one or more of: the gear of the vehicle being neither in the forward gear nor in the reverse gear, the torque of the driving motor being less than a second torque, and the vehicle speed of the vehicle being greater than or equal to a second vehicle speed, and
the first torque is greater than the second torque, and the first vehicle speed is less than the second vehicle speed.

13. The method according to claim 1, wherein the vehicle comprises a spill valve configured to control a flow rate of the coolant flowing through the cooling flow path of the driving motor, and the method further comprises:
after the engine is started to cool the driving motor, in response to that the flow rate of the coolant flowing through the cooling flow path of the driving motor is greater than a third cooling flow rate, controlling the spill valve of the vehicle to enter a closed state.

14. A device for cooling a driving motor of a vehicle with a locked rotor,
the vehicle comprising a driving motor, an engine, an engine end oil pump, and a cooling flow path, the engine being configured to drive the engine end oil pump to run, and the cooling flow path connecting the engine end oil pump to the driving motor,
the device comprising:
a controller, configured to execute a method for cooling the driving motor of the vehicle.

15. A non-transitory computer-readable storage medium storing a computer program, wherein the computer program, when executed by a processor, causes the processor to perform operations comprising:
cooling a driving motor with a locked rotor of a vehicle, the vehicle comprising the driving motor, an engine, an engine end oil pump, and a cooling flow path, the engine being configured to drive the engine end oil pump, and the cooling flow path connecting the engine end oil pump to the driving motor,
the cooling the driving motor comprising:
in response to determining that a driving mode of the vehicle is an electric mode and that the vehicle meets a locked rotor motor trigger condition, and detecting that a current temperature of the driving motor is greater than an auxiliary cooling starting temperature of the engine, controlling the engine to start to cause the engine end oil pump to drive a coolant in the cooling flow path to cool the driving motor.

16. A vehicle, comprising a driving motor, an engine, an engine end oil pump, a cooling flow path, and a controller;
the engine being configured to drive the engine end oil pump;
the cooling flow path connecting the engine end oil pump to the driving motor; and
a temperature detector configured to detect a current temperature of the driving motor;
the controller being configured to perform operations comprising:
in response to determining that a driving mode of the vehicle is an electric mode and that the vehicle meets a locked rotor motor trigger condition, and that the current temperature of the driving motor is greater than an auxiliary cooling starting temperature of the engine, controlling the engine to start to cause the engine end oil pump to drive a coolant in the cooling flow path to cool the driving motor.

17. The vehicle according to claim 16, wherein the operations further comprise:
determining a first duration for a temperature of the driving motor to reach a first temperature according to a temperature change rate of the driving motor and the current temperature of the driving motor; and
in response to that the first duration is less than or equal to a first preset duration, reducing the auxiliary cooling starting temperature of the engine.

18. The vehicle according to claim 17, wherein in response to that the first duration is less than or equal to the first preset duration, the reducing the auxiliary cooling starting temperature of the engine comprises:
determining a target correction offset based on the temperature change rate of the driving motor and a relationship between the temperature change rate and a correction offset; and
determining a difference between the first temperature and the target correction offset as the auxiliary cooling starting temperature of the engine.

19. The vehicle according to claim 17, wherein in response to that the first duration is less than or equal to the first preset duration, the reducing the auxiliary cooling starting temperature of the engine comprises:
setting the auxiliary cooling starting temperature of the engine to be equal to a second temperature less than the first temperature.

20. The vehicle according to claim 17, wherein the operations further comprise:
in response to that the first duration is greater than the first preset duration, setting the auxiliary cooling starting temperature of the engine to be equal to the first temperature.
